(19) United States
(12) Patent Application Publication
(10) Pub. No.: US 2006/0257770 A1
(43) Pub. Date: Nov. 16, 2006

(54) Photoreceptors

(75) Inventors: Kent J. Evans, Lima, NY (US); David M. Skinner, Rochester, NY (US); Min-Hong Fu, Webster, NY (US); Kathleen M. Carmichael, Williamson, NY (US); June E. Schneider, Honeoye Falls, NY (US); John A. Bergfjord SR., Macedon, NY (US); Susan M. VanDusen, Williamson, NY (US)

Correspondence Address: Carter, DeLuca, Farrell & Schmidt, LLP, 445 Broadhollow Road, Melville, NY, 11747, US

(73) Assignee: Xerox Corporation

(21) Appl. No.: 11/125,484

(22) Filed: May 10, 2005

(51) Int. Cl. G03G 5/047

(52) U.S. Cl. 430/59.4; 430/56; 430/96; 430/59.1; 430/58.65

(57) ABSTRACT

Dispersions for producing photogenerator layers of photoreceptors are provided. The dispersions include a resin, a photogenerating component, and an adhesive.

### BACKGROUND

The present disclosure relates to imaging members and, more specifically, to methods for forming photogenerator layers of imaging members utilized in photoreceptors.

In the art of electrophotography, an electrophotographic member having a photoconductive insulating layer on a conductive layer is imaged by first uniformly electrostatically charging the surface of the photoconductive insulating layer. The member is then exposed to a pattern of activating electromagnetic radiation such as light, which selectively dissipates the charge in the illuminated areas of the photoconductive insulating layer while leaving behind an electrostatic latent image in the non-illuminated areas. This electrostatic latent image may then be developed to form a visible image by depositing finely divided electroscopic toner particles, for example, from a developer composition, on the surface of the photoconductive insulating layer. The resulting visible toner image can be transferred to a suitable receiving member, such as paper. This imaging process may be repeated many times with reusable electrophotographic imaging members.

The electrophotographic imaging members, i.e., photoreceptors, may be in the form of plates, drums, flexible belts, and the like. Electrophotographic photoreceptors may be prepared using either a single layer configuration or a multilayer configuration, but the multilayer arrangement is more common. Multilayered photoreceptors may include a substrate, a conductive layer, an optional hole blocking layer, an optional adhesive layer, a photogenerator layer, a charge transport layer, an optional overcoating layer and, in some belt embodiments, an anticurl backing layer. In the multilayer configuration, the active layers of the photoreceptor are the photogenerator layer (CGL) and the charge transport layer (CTL).

One type of multilayered photoreceptor includes a layer of finely divided particles of a photoconductive inorganic compound dispersed in an electrically insulating organic resin binder. In U.S. Pat. No. 4,265,990, the entire disclosure of which is incorporated herein by this reference, a layered photoreceptor is disclosed having separate charge generation (photogenerating) layers and charge transport layers. The photogenerator layer is capable of photogenerating holes and injecting the photogenerated holes into the charge transport layer.

Flexible photoreceptor belts may be fabricated by depositing the various layers of photoactive coatings onto long webs which are thereafter cut into sheets. These flexible photoreceptor belts often include a supporting substrate, an undercoat hole blocking layer, an interfacial adhesive layer, a photogenerator layer and a charge transport layer. In some cases an anticurl layer may be applied to the underside of the substrate support. While each of these layers serves a unique functional purpose, the multiple layer format adds to the complexity of the coating operations utilized in producing these photoreceptors and increases manufacturing costs.

Photoreceptors having simpler structures and lower manufacturing costs are thus desirable.

### SUMMARY

The present disclosure provides a photoreceptor possessing a photogenerator layer having a mixture of a resin, a photogenerating component, and an adhesive component. In embodiments, the photoreceptor also possesses a charge transport layer which, in embodiments, includes hole transport molecules of an aryl amine.

The present disclosure also provides a photoreceptor having a charge transport layer and a photogenerator layer including a resin, about 5 weight percent to about 80 weight percent of a photogenerating component which can be a metal phthalocyanine, metal free phthalocyanine, alkylhydroxyl gallium phthalocyanine, hydroxygallium phthalocyanine and/or a perylene, and about 1 weight percent to about 20 weight percent of an adhesive which may be a polyarylate, a polyurethane, or a mixture of at least one of these adhesives with a carbazole polymer.

In embodiments, the resin may be a polycarbonate, the photogenerating component may be a hydroxygallium phthalocyanine or a bis(benzimidazo)perylene, and the adhesive component may be a polyarylate. In embodiments, the polyarylate adhesive may be prepared from bisphenol-A and a mixture of 50 mol percent each of terephthalic and isophthalic acid chlorides.

The present disclosure also provides compositions including a resin, a photogenerating component, and an adhesive component.

### DETAILED DESCRIPTION OF THE PREFERRED EMBODIMENTS

The present disclosure provides novel dispersions which are utilized to prepare photogenerator layers for use on a photoreceptor, especially a multi-layer flexible belt photoreceptor. The dispersions include a resin, a photogenerating component, and at least one adhesive. By including the adhesive in the dispersion utilized to form the photogenerator layer of a photoreceptor, the photoreceptor does not require a separate interfacial adhesive layer, which simplifies the construction and reduces the cost of a photoreceptor possessing such a photogenerator layer.

Any suitable film forming polymer or combination of film forming polymers can be utilized as the resin to form the dispersion. Examples of suitable resins for use in the dispersion include thermoplastic and thermosetting resins such as polycarbonates, polyesters including poly(ethylene terephthalate), polyurethanes including poly(tetramethylene hexamethylene diurethane), polystyrenes including poly(styrene-co-maleic anhydride), polybutadienes including polybutadiene-graft-poly(methyl acrylate-co-acrylontrile), polysulfones including poly(1,4-cyclohexane sulfone), polyarylethers including poly(phenylene oxide), polyarylsulfones including poly(phenylene sulfone), polyethersulfones including poly(phenylene oxide-co-phenylene sulfone), polyethylenes including poly(ethylene-co-acrylic acid), polypropylenes, polymethylpentenes, polyphenylene sulfides, polyvinyl acetates, polyvinylbutyrals, polysiloxanes including poly(dimethylsiloxane), polyacrylates including poly(ethyl acrylate), polyvinyl acetals, polyamides including poly(hexamethylene adipamide), polyimides including poly(pyromellitimide), amino resins including poly(vinyl amine), phenylene oxide resins including poly(2,6-dimethyl-1,4-phenylene oxide), terephthalic acid resins, phenoxy resins including poly(hydroxyethers), epoxy resins including poly([(o-cresyl glycidyl ether)-co-formaldehyde], phenolic resins including poly(4-tert-butylphenol-co-formaldehyde), polystyrene and acrylonitrile copolymers, polyvinylchlorides, polyvinyl alcohols, poly-N-vinylpyrrolidinones, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and the like, and combinations thereof. These polymers may be block, random, or alternating copolymers.

Examples of suitable polycarbonates which may be utilized to form the dispersion include, but are not limited to, poly(4,4′-isopropylidene diphenyl carbonate) (also referred to as bisphenol A polycarbonate), poly(4,4′-diphenyl-1,1′-cyclohexane carbonate) (also referred to as bisphenol Z polycarbonate, polycarbonate Z, or PCZ), poly(4,4′-sulfonyl diphenyl carbonate) (also referred to as bisphenol S polycarbonate), poly(4,4′-ethylidene diphenyl carbonate) (also referred to as bisphenol E polycarbonate), poly(4,4′-methylidene diphenyl carbonate) (also referred to as bisphenol F polycarbonate), poly(4,4′-(1,3-phenylenediisopropylidene)diphenyl carbonate) (also referred to as bisphenol M polycarbonate), poly(4,4′-(1,4-phenylenediisopropylidene)diphenyl carbonate) (also referred to as bisphenol P polycarbonate), poly(4,4′-hexafluoroisppropylidene diphenyl carbonate).

Resins used to form the dispersion may possess molecular weights from about 10,000 to about 100,000, in embodiments from about 15,000 to about 50,000.

The resin may be present in the dispersion in amounts of from about 20 percent to about 95 percent by weight of the solids of the dispersion and, in embodiments, from about 40 percent to about 75 percent by weight of the solids of the dispersion. The expression “solids” refers, in embodiments, to the photogenerating component particles, adhesive particles and binder components of the coating dispersion.

Suitable photogenerating components which may be added to the dispersion include known photogenerating components, such as metal phthalocyanines, metal free phthalocyanines, alkylhydroxyl gallium phthalocyanine, hydroxygallium phthalocyanines, titanyl phthalocyanines, perylenes, especially bis(benzimidazo)perylenes (BZP), and the like. In embodiments, vanadyl phthalocyanines, Type V hydroxygallium phthalocyanines, BZP, and inorganic components such as selenium, selenium alloys, and trigonal selenium may be utilized as the photogenerating component.

In embodiments, hydroxygallium phthalocyanaine (HOGaPc) may be utilized as the photogenerating component. HOGaPc is thoroughly described in U.S. Pat. Nos. 5,521,306 and 5,473,064, the entire disclosures of each of which are herein incorporated by reference. Both patents describe processes to prepare Type V hydroxygallium phthalocyanine.

In embodiments, a BZP may be utilized as the photogenerating component. One suitable BZP which may be utilized is described in U.S. Pat. No. 4,587,189, the entire disclosure of which is incorporated herein by reference. The BZP described in U.S. Pat. No. 4,587,189 includes a mixture of bisbenzimidazo(2,1-a-1′,2′-b)anthra(2,1,9-def:6,5,10-d′e′f′)diisoquinoline-6,11-dione and bisbenzimidazo(2,1-a:2′,1′-a)anthra(2,1,9-def:6,5,10-d′e′f′)diisoquinoline-10,21-dione.

The photogenerating component may be present in the dispersion in any suitable or desired amounts such that the resulting photogenerator layer prepared therefrom possesses the desired level of photogenerating component. The photogenerating component may be present in the dispersion, and thus the photogenerator layer, in an amount of from about 5 percent to about 80 percent by weight of the solids and, in embodiments, from about 25 percent to about 60 percent by weight of the solids.

Adhesives which may be added to the dispersions utilized to form the photogenerator layer include, but are not limited to, polyarylates, polyurethanes, polysulfones (available from Amoco Production Products), polyesters (MOR-ESTER 49,000, available from Morton International Inc.), Vitel PE-100, Vitel PE-200D and Vitel PE222, (available from Good Year Tire and Rubber Co.) and/or polymer blends of at least one of these polymers. The polymer adhesives must be compatible with the photogenerating component and binder and soluble in the same solvent as the binder. The adhesives also are capable of forming a stable dispersion with no phase separation, providing a homogenous solid film having excellent adhesion and coatability for use as a photogenerator layer.

In embodiments, a polyarylate may be utilized as the adhesive. Polyarylates may be derived from aromatic dicarboxylic acids and diphenols utilizing known methods. In embodiments, a suitable polyarylate may have repeating units represented by the following formula:

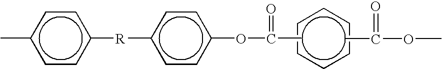

wherein R may be C₁-C₆ alkylene. In embodiments R may be a C₃ alkylene.

Suitable polyarylates may have a weight average molecular weight from about 5,000 to about 200,000, in embodiments from about 30,000 to about 80,000.

In embodiments, the polyarylate polymers have recurring units of the formula:

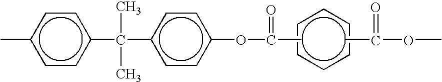

The phthalate moiety may be isophthalic acid, terephthalic acid, or a mixture of the two. In embodiments, the phthalate moiety may be a mixture of isophthalic acid and terephthalic acid at any suitable ratio from about 99 mol percent to about 1 mol percent isophthalic acid and about 1 mol percent to about 99 mol percent terephthalic acid, in embodiments from about 75 to about 25 mol percent isophthalic acid and from about 25 to about 75 mol percent terephthalic acid.

In embodiments, the phthalate moiety may be a mixture of about 75 percent isophthalic acid and about 25 percent terephthalic acid. The phthalate moiety may also be a mixture of about 50 percent isophthalic acid and about 50 percent terephthalic acid.

Examples of suitable polyarylates include those sold under the name ARDEL® from Amoco Performance Products and DUREL® from Celanese Chemical Company. One suitable polyarylate polymer is available from Amoco Performance Products under the tradename ARDEL® D-100. ARDEL® D-100 is prepared from bisphenol-A and a mixture of 50 mol percent each of terephthalic and isophthalic acid chlorides. ARDEL® D-100 has a melt flow at 375° C. of 4.5 g/10 minutes, a density of 1.21 Mg/m3, a refractive index of 1.61, a tensile strength at yield of 69 MPa, a thermal conductivity (k) of 0.18 W/m° K and a volume resistivity of 3×016 ohm-cm. DUREL® is an amorphous homopolymer with a weight average molecular weight of about 20,000 to about 200,000. Suitable polyarylates also include those disclosed in U.S. Pat. Nos. 6,699,850 and 5,492,785, the entire disclosures of each of which are incorporated herein by reference. More than one polyarylate may be blended in the compositions of the present disclosure.

The adhesive may be present in the dispersion in any suitable or desired amounts. In embodiments, the adhesive may be present in the dispersion, and thus the photogenerator layer, in an amount of from about 1 percent to about 20 percent by weight of the solids and, in embodiments, from about 3 percent to about 12 percent by weight of the solids. The adhesive may be added by substituting a portion of the binder with the adhesive.

In embodiments, it may be desirable to utilize a liquid with the dispersion to form the photogenerator layer. In such a case, the resin may be added to a liquid which is a solvent for the resin to form a solution and the photogenerating component and adhesive then added to form the dispersion. In embodiments the liquid is also a solvent for the adhesive. Any liquid utilized should not substantially disturb or adversely affect any other previously coated layers of the photoreceptor device. Examples of liquids that can be utilized as coating solvents for the photogenerator layers are ketones, alcohols, aromatic hydrocarbons, halogenated aliphatic hydrocarbons, ethers, amines, amides, esters, mixtures thereof, and the like. Specific examples include cyclohexanone, acetone, methyl ethyl ketone, methanol, ethanol, butanol, amyl alcohol, toluene, xylene, monochlorobenzene, carbon tetrachloride, chloroform, methylene chloride, trichloroethylene, tetrahydrofuran, dioxane, diethyl ether, dimethyl formamide, dimethyl acetamide, butyl acetate, ethyl acetate, methoxyethyl acetate, mixtures thereof, and the like.

Any suitable technique may be utilized to disperse the photogenerating component particles and adhesive in the resin or resins. The dispersion containing the photogenerating component and adhesive may be formed using, for example, attritors, ball mills, Dynomills, paint shakers, homogenizers, microfluidizers, mechanical stirrers, in-line mixers, or by any other suitable milling techniques.

In embodiments, dispersion techniques which may be utilized include, for example, ball milling, roll milling, milling in vertical or horizontal attritors, sand milling, and the like. The solids content of the mixture being milled can be selected from a wide range of concentrations. Milling times using a ball roll mill may be between about 2 hours and about 8 days, in embodiments from about 8 hours to about 4 days.

The amount of adhesive needed in the dispersion to provide sufficient adhesion for the resulting photogenerator layer may vary depending on the materials utilized to form the photogenerator layer. For example, 4% of a polyarylate adhesive in a PCZ resin utilizing BZP as a photogenerating component may provide sufficient adhesion, while 10% of the same polyarylate adhesive in the same PCZ resin may be required to provide sufficient adhesion where a HOGaPc is utilized as the photogenerating component.

Any suitable and conventional technique may be utilized to apply the dispersion of the present disclosure to another layer of a photoreceptor to form a photogenerator layer thereon. Suitable coating techniques include slot coating, gravure coating, roll coating, spray coating, spring wound bar coating, dip coating, draw bar coating, reverse roll coating, rotary atomizers, and the like.

In embodiments the photogenerator layer may be applied to a belt photoreceptor by extrusion or roll coating techniques. Drying of the deposited coating may be effected by any suitable conventional technique such as oven drying, infrared radiation drying, air drying and the like.

The photogenerator layer containing photogenerating component, adhesive, and the resinous binder possesses a thickness from about 0.05 microns to about 10 microns. In embodiments the thickness of the resulting photogenerator layer may be from about 0.1 microns to about 5 microns, in embodiments from about 0.3 microns to about 3 microns. The photogenerator layer thickness is related to the relative amounts of photogenerating component, adhesive, and binder. Higher binder content compositions generally require thicker layers for photogeneration. Generally, it may be desirable to provide this layer in a thickness sufficient to absorb about 90 percent or more of the incident radiation which is directed upon it in the imagewise or printing exposure step. The maximum thickness of this layer depends upon factors such as mechanical considerations, the specific photogenerating compound selected, the thicknesses of the other layers, and whether a flexible photoreceptor is desired.

The methods of the present disclosure may be utilized to form photogenerator layers for use with any known configuration of photoreceptors. Suitable configurations of multi-layer photoreceptors include the photoreceptors described in U.S. Pat. Nos. 6,800,411, 6,824,940, 6,818,366, 6,790,573, and U.S. Patent Application Publication No. 20040115546, the entire contents of each of which are incorporated by reference herein. Photoreceptors may possess a photogenerator layer (CGL), which may be referred to, in embodiments, as a photogenerating layer, and a charge transport layer (CTL). Other layers, including a substrate, an electrically conductive layer, a charge blocking or hole blocking layer, an adhesive layer, and/or an overcoat layer, may also be present in the photoreceptor.

Suitable substrates which may be utilized in forming a photoreceptor include opaque or substantially transparent substrates, and may include any suitable organic or inorganic material having the requisite mechanical properties.

The substrate may be flexible, seamless, or rigid and may be of a number of different configurations such as, for example, a plate, a cylindrical drum, a scroll, an endless flexible belt, a web, and the like.

The thickness of the substrate layer may depend on numerous factors, including mechanical performance and economic considerations. For rigid substrates, a thickness from about 0.3 millimeters to about 10 millimeters, in embodiments from about 0.5 millimeters to about 5 millimeters may be utilized. For flexible substrates, a thickness from about 65 to about 200 micrometers, in embodiments from about 75 to about 100 micrometers may be utilized, for optimum flexibility and minimum stretch when cycled around small diameter rollers of, for example, 19 millimeter diameter. The entire substrate can be made of an electrically conductive material, or the electrically conductive material can be a coating on a polymeric substrate.

Substrate layers selected for the imaging members of the present disclosure, and which substrates can be opaque or substantially transparent, may include a layer of insulating material including inorganic or organic polymeric materials such as KALEDEX™ 2000 (a polyethylene naphthalate from ICI Americas, Inc.), MYLAR® (a commercially available polymer from DuPont), MYLAR® containing titanium, a layer of an organic or inorganic material having a semiconductive surface layer, such as indium tin oxide or aluminum arranged thereon, or a conductive material inclusive of aluminum, chromium, nickel, brass, or the like.

Any suitable electrically conductive material can be employed with the substrate. Suitable electrically conductive materials include copper, brass, nickel, zinc, chromium, stainless steel, conductive plastics and rubbers, aluminum, semi-transparent aluminum, steel, cadmium, silver, gold, zirconium, niobium, tantalum, vanadium, hafnium, titanium, nickel, chromium, tungsten, molybdenum, paper rendered conductive by the inclusion of a suitable material therein, or through conditioning in a humid atmosphere to ensure the presence of sufficient water content to render the material conductive, indium, tin, metal oxides, including tin oxide and indium tin oxide, and the like.

After formation of an electrically conductive surface, a hole blocking layer may optionally be applied to the substrate layer. Generally, hole blocking layers (also referred to as charge blocking layers) allow electrons from the conductive layer to migrate toward the photogenerator layer. Any suitable blocking layer capable of forming an electronic barrier to holes between the adjacent photogenerator layer and the underlying conductive layer of the substrate may be utilized. Suitable blocking layers include those disclosed, for example, in U.S. Pat. Nos. 4,286,033, 4,291,110 and 4,338,387, the entire disclosures of each of which are incorporated herein by reference. Similarly, illustrated in U.S. Pat. Nos. 6,255,027, 6,177,219, and 6,156,468, the entire disclosures of each of which are incorporated herein by reference, are, for example, photoreceptors containing a hole blocking layer of a plurality of light scattering particles dispersed in a binder. For example, Example 1 of U.S. Pat. No. 6,156,468 discloses a hole blocking layer of titanium dioxide dispersed in a linear phenolic binder.

Suitable hole blocking layers utilized for negatively charged photoreceptors may include, for example, polyamides including LUCKAMIDE® (a nylon type material derived from methoxymethyl-substituted polyamide commercially available from Dai Nippon Ink), hydroxy alkyl methacrylates, nylons, gelatin, hydroxyl alkyl cellulose, organopolyphosphazines, organosilanes, organotitanates, organozirconates, metal oxides of titanium, chromium, zinc, tin, silicon, and the like. In embodiments the hole blocking layer may include nitrogen containing siloxanes. Nitrogen containing siloxanes may be prepared from coating solutions containing a hydrolyzed silane. Hydrolyzable silanes include 3-aminopropyl triethoxy silane, N,N′-dimethyl 3-amino)propyl triethoxysilane, N,N-dimethylamino phenyl triethoxy silane, N-phenyl aminopropyl trimethoxy silane, trimethoxy silylpropyldiethylene triamine and mixtures thereof.

In embodiments, the hole blocking components may be combined with phenolic compounds, a phenolic resin, or a mixture of more than one phenolic resin, for example, from about 2 to about 4 phenolic resins. Suitable phenolic compounds which may be utilized may contain at least two phenol groups, such as bisphenol A(4,4′-isopropylidenediphenol), bisphenol E(4,4′-ethylidenebisphenol), bisphenol F(bis(4-hydroxyphenyl)methane), bisphenol M(4,4′-(1,3-phenylenediisopropylidene)bisphenol), bisphenol P(4,4′-(1,4-phenylene diisopropylidene)bisphenol), bisphenol S(4,4′-sulfonyldiphenol), and bisphenol Z(4,4′-cyclohexylidenebisphenol), hexafluorobisphenol A(4,4′-(hexafluoro isopropylidene)diphenol), resorcinol, hydroxyquinone, catechin, and the like.

The hole blocking layer may be applied as a coating on a substrate or electrically conductive layer by any suitable conventional technique such as spraying, die coating, dip coating, draw bar coating, gravure coating, silk screening, air knife coating, reverse roll coating, vacuum deposition, chemical treatment, and the like. For convenience in obtaining thin layers, the blocking layers may be applied in the form of a dilute solution, with the solvent being removed after deposition of the coating by conventional techniques such as by vacuum, heating and the like. Drying of the deposited coating may be effected by any suitable conventional technique such as oven drying, infrared radiation drying, air drying and the like.

The blocking layer may be continuous and have a thickness of from about 0.005 micrometers to about 30 micrometers, in embodiments from about 0.02 micrometers to about 8 micrometers.

In embodiments the photoreceptor also includes a charge transport layer attached to the photogenerator layer. The charge transport layer in embodiments includes a charge transport or hole transport molecule (HTM) dispersed in an inactive polymeric material. These compounds may be added to polymeric materials which are otherwise incapable of supporting the injection of photogenerated holes from the photogenerator layer and incapable of allowing the transport of these holes therethrough. The addition of these HTMs converts the electrically inactive polymeric material to a material capable of supporting the direction of photogenerated holes from the photogenerator layer and capable of allowing the transport of these holes through the charge transport layer in order to discharge the surface charge on the charge transport layer.

Suitable polymers for use in forming the charge transport layer are film forming resins known to those skilled in the art. Examples include those polymers utilized to form the photogenerator layer. In embodiments resin materials for use in forming the charge transport layer are electrically inactive resins including polycarbonate resins having a weight average molecular weight from about 20,000 to about 150,000, in embodiments from about 50,000 about 120,000. Electrically inactive resin materials which may be utilized in the charge transport layer include poly(4,4′-dipropylidene-diphenylene carbonate) with a weight average molecular weight of from about 35,000 to about 40,000, available as LEXAN® 145 from General Electric Company; poly(4,4′-propylidene-diphenylene carbonate) with a weight average molecular weight of from about 40,000 to about 45,000, available as LEXAN® 141 from the General Electric Company; a polycarbonate resin having a weight average molecular weight of from about 50,000 to about 100,000, available as MAKROLON® from Farbenfabricken Bayer A.G.; a polycarbonate resin having a weight average molecular weight of from about 20,000 to about 50,000 available as MERLON® from Mobay Chemical Company; and polycarbonate resins having a weight average molecular weight of from about 20,000 to about 80,000 available as PCZ from Mitsubishi Chemical Co., including a poly(4,4′-diphenyl-1,1′-cyclohexane carbonate) with a molecular weight of from about 35,000 to about 40,000, available as PCZ 400 from Mitsubishi Chemical Co. Solvents such as methylene chloride, tetrahydrofuran, toluene, monochlorobenzene, or mixtures thereof, may be utilized in forming the charge transport layer coating mixture.

Any suitable charge transporting or electrically active molecules known to those skilled in the art may be employed as HTMs in forming a charge transport layer on a photoreceptor. Suitable charge transporting molecules include, for example, aryl amines as disclosed in U.S. Pat. No. 4,265,990, the entire contents of which are incorporated by reference herein. In embodiments, an aryl amine charge hole transporting component may be represented by: 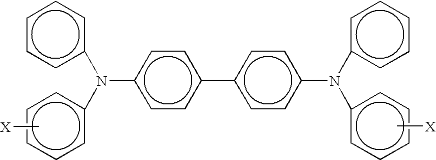
wherein X is selected from the group consisting of alkyl, halogen, alkoxy or mixtures thereof. In embodiments, the halogen is a chloride. Alkyl groups may contain, for example, from about 1 to about 10 carbon atoms and, in embodiments, from about 1 to about 5 carbon atoms. Examples of suitable aryl amines include, but are not limited to, N,N′-diphenyl-N,N′-bis(alkylphenyl)-1,1-biphenyl-4,4′-diamine, wherein the alkyl may be methyl, ethyl, propyl, butyl, hexyl, and the like; and N,N′-diphenyl-N,N′-bis(halophenyl)-1,1′-biphenyl-4,4′-diamine, wherein the halo may be a chloro, bromo, fluoro, and the like substituent.

Other suitable aryl amines which may be utilized as an HTM in a charge transport layer include, but are not limited to, tritolylamine, N,N′-bis(3,4dimethylphenyl)-N″(1-biphenyl)amine, 2-bis((4′-methylphenyl)amino-p-phenyl)1,1-diphenyl ethylene, 1-bisphenyl-diphenylamino-1-propene, triphenylmethane, bis(4-diethylamine-2-methylphenyl)phenylmethane, 4′-4″-bis(diethylamino)-2′,2″-dimethyltriphenylmethane, N,N′-bis(alkylphenyl)-[1,1′-biphenyl]-4,4′-diamine wherein the alkyl is, for example, methyl, ethyl, propyl, n-butyl, and the like, N,N′-diphenyl-N,N′-bis(3″-methylphenyl)-(1,1′-biphenyl)-4,4′-diamine, and the like.

The weight ratio of the polymer binder to charge transport molecules in the resulting charge transport layer can vary, for example, from about 80/20 to about 30/70. In embodiments the weight ratio of the polymer binder to charge transport molecules can vary from about 70/30 to about 40/60, in embodiments from about 60/40 to about 50/50.

Any suitable and conventional technique may be utilized to mix the polymer binder in combination with the hole transport material and apply same as a charge transport layer to a photoreceptor. In embodiments, it may be advantageous to add the polymer binder and hole transport material to a solvent to aid in formation of a charge transport layer and its application to a photoreceptor. Examples of solvents which may be utilized include aromatic hydrocarbons, aliphatic hydrocarbons, halogenated hydrocarbons, ethers, amides and the like, or mixtures thereof. In embodiments, a solvent such as cyclohexanone, cyclohexane, chlorobenzene, carbon tetrachloride, chloroform, methylene chloride, trichloroethylene, toluene, tetrahydrofuran, dioxane, dimethyl formamide, dimethyl acetamide and the like, may be utilized in various amounts. Suitable application techniques of the charge transport layer include spraying, slot or slide coating, dip coating, roll coating, wire wound rod coating, and the like. Drying of the deposited coating may be effected by any suitable conventional technique such as oven drying, infrared radiation drying, air drying and the like.

The thickness of the charge transport layer can vary from about 2 micrometers to about 50 micrometers, in embodiments from about 10 micrometers to about 35 micrometers. The charge transport layer should be an insulator to the extent that the electrostatic charge placed on the charge transport layer is not conducted in the absence of illumination at a rate sufficient to prevent formation and retention of an electrostatic latent image thereon. In general, the ratio of the thickness of the charge transport layer to the photogenerator layer, where present, is from about 2:1 to 200:1 and in some instances as great as 400:1.

The dispersion of the present disclosure may be applied to any other layer of a photoreceptor, including a suitable electrically conductive layer or a charge transport layer. When used in combination with a charge transport layer, the photogenerator layer may be sandwiched between a conductive surface and a charge transport layer or the charge transport layer may be sandwiched between a conductive surface and a photogenerator layer.

The photogenerator layer, charge transport layer, and other layers may be applied in any suitable order to produce either positive or negative charging photoreceptors. For example, the photogenerator layer may be applied prior to the charge transport layer, as illustrated in U.S. Pat. No. 4,265,990, or the charge transport layer may be applied prior to the photogenerator layer, as illustrated in U.S. Pat. No. 4,346,158, the entire disclosures of each of which are incorporated by reference herein. When used in combination with a charge transport layer, the photogenerator layer may be sandwiched between a conductive surface and a charge transport layer or the charge transport layer may be sandwiched between a conductive surface and a photogenerator layer.

Optionally, an overcoat layer may be applied to the surface of a photoreceptor to improve resistance to abrasion. In some cases, an anti-curl back coating may be applied to the side of the substrate opposite the active layers of the photoreceptor (i.e., the CGL and CTL) to provide flatness and/or abrasion resistance where a web configuration photoreceptor is fabricated. These overcoating and anti-curl back coating layers are well known in the art and may include thermoplastic organic polymers or inorganic polymers that are electrically insulating or slightly semi-conductive. For example, overcoat layers may be fabricated from a dispersion including a particulate additive in a resin. Suitable particulate additives for overcoat layers include metal oxides including aluminum oxide, non-metal oxides including silica or low surface energy polytetrafluoroethylene, and combinations thereof. Suitable resins include those described above as suitable for photogenerator layers and/or charge transport layers, for example, polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof. Overcoatings may be continuous and have a thickness from about 0.5 micrometers to about 10 micrometers, in embodiments from about 2 micrometers to about 6 micrometers.

An example of an anti-curl backing layer is described in U.S. Pat. No. 4,654,284, the entire disclosure of which is incorporated herein by reference. In other embodiments, it may be desirable to coat the back of the substrate with an anticurl layer such as, for example, polycarbonate materials commercially available as MAKROLON® from Bayer Material Science. The thickness of anti-curl backing layers should be sufficient to substantially balance the total forces of the layer or layers on the opposite side of the supporting substrate layer. A thickness for an anti-curl backing layer from about 0 micrometers to about 35 micrometers, in embodiments from about 7 micrometers to about 24 micrometers, is a satisfactory range for flexible photoreceptors.

Photoreceptors produced by doping an adhesive directly into the photogenerator layer without the need for a separate adhesive layer have been found to have peel strength and electrical properties comparable to those photoreceptors having a separate interfacial adhesive layer. Thus, the doped coatings and methods of the present disclosure provide a less complex approach for the production of photoreceptors and result in a decrease in manufacturing costs. The elimination of the need for a separate adhesive layer also offers potential yield increase by avoiding the possible yield loss associated with adhesive coatings.

The dispersions of the present disclosure, when applied as a photogenerator layer in a photoreceptor, also provide excellent xerographic characteristics, such as photoinduced discharge characteristics and cyclic and environmental stability.

Processes of imaging, especially xerographic imaging and printing, are also encompassed by the present disclosure. More specifically, photoreceptors of the present disclosure can be selected for a number of different known imaging and printing processes including, for example, electrophotographic imaging processes, especially xerographic imaging and printing processes wherein charged latent images are rendered visible with toner compositions of an appropriate charge polarity. Moreover, the imaging members of this disclosure may be useful in color xerographic applications, particularly high-speed color copying and printing processes.

The following Examples illustrate embodiments of the present disclosure. These Examples are intended to be illustrative only and are not intended to limit the scope of the present disclosure. Also, parts and percentages are by weight unless otherwise indicated.

### EXAMPLE 1

Preparation of Photogenerating Layer and Transport Layer of Imaging Member. An imaging member was prepared by providing a 0.02 micrometer thick titanium layer coated on a biaxially oriented polyethylene naphthalate substrate (KALEDEX™ 2000) having a thickness of 3.5 mils. A solution containing 50 grams 3-amino-propyltriethoxysilane, 41.2 grams water, 15 grams acetic acid, 684.8 grams of 200 proof denatured alcohol, and 200 grams heptane was applied thereto with a gravure applicator. This layer was then dried for about 5 minutes at 135° C. in a forced air drier. The resulting hole blocking layer had a dry thickness of 500 angstroms.

An adhesive layer was then prepared by applying a wet coating over the blocking layer, using a gravure applicator. The adhesive layer contained polyarylate adhesive (ARDEL® D-100 available from Toyota Hsutsu Inc.) in a 60:30:10 volume ratio mixture of tetrahydrofuran/monochlorobenzene/methylene chloride. The adhesive was present in an amount of about 0.2 percent by weight based on the total weight of the solution. The adhesive layer was then dried for about 5 minutes at 135° C. in a forced air dryer. The resulting adhesive layer had a dry thickness of 200 angstroms.

A photogenerating layer dispersion was prepared by introducing 0.45 grams of PCZ 200 (LUPILON200® available from Mitsubishi Gas Chemical Corp.) and 50 ml of tetrahydrofuran into a 4 oz. glass bottle. To this solution were added 2.4 grams of bis(benzimidazo)perylene (BZP) and 300 grams of ⅛ inch (3.2 millimeter) diameter stainless steel shot. This mixture was then placed on a ball mill for 4 days. Subsequently, 2.25 grams of PCZ 200 was dissolved in 46.1 grams of tetrahydrofuran, and added to this BZP slurry. This slurry was then placed on a shaker for 10 minutes. The resulting slurry was then applied to the adhesive interface with a Bird bar applicator to form a photogenerator layer having a wet thickness of 0.50 mil. A strip about 10 mm wide along one edge of the substrate web bearing the blocking layer and the adhesive layer was deliberately left uncoated without any photogenerating layer material to facilitate adequate electrical contact by a ground strip layer applied at a later time. The photogenerator layer was dried at 120° C. for 1 minute in a forced air oven to form a dry charge layer having a thickness of 1.1 micrometers.

A transport layer was formed with a solution containing 43 weight percent (based on the total solids) of the hole transport compound, N,N′-diphenyl-N,N′-bis(3-methyl-pheny)-(1,1′-biphenyl)-4,4′-diamine. In a four ounce brown bottle, 11.4 grams of Makrolon® 5705 (available from Bayer Chemicals) was dissolved in 113 grams of methylene chloride. After the polymer was completely dissolved, 8.6 grams of N,N′-diphenyl-N,N′-bis(3-methylphenyl)-1,1′-biphenyl-4,4′-diamine was added to the solution. The mixture was shaken overnight to assure a complete solution. The solution was applied onto the photogenerating layer using a 4 mil Bird bar to form a coating. The coated device was then heated in a forced air oven at 120° C. for 1 minute to form a charge transport layer having a dry thickness of 24 micrometers.

### EXAMPLES 2-6

For Examples 2-6, photoreceptors were prepared as in Example 1 except they contained no adhesive layer and had varying amounts of ARDEL® D-100 polyarylate adhesive in the photogenerator layer (based on the overall solids of the photogenerator layer). Example 2 had 0% ARDEL® D-100 added to the photogenerator layer; Example 3 had 4% ARDEL® D-100; Example 4 had 6% ARDEL® D-100; Example 5 had 8% ARDEL® D-100; and Example 6 had 10% ARDEL® D-100.

### EXAMPLE 7

A photoreceptor was prepared as in Example 1 except for the following. The photogenerator layer was prepared by using 2.4 grams of Type V hydroxygallium phthalocyanine (HOGaPc) in place of bis(benzimidazo)perylene (BZP). The photogenerator layer had a wet thickness of 0.25 mil and a dry thickness of 0.4 micrometers. The transport layer was coated with a solution containing 50 weight percent (based on the total solids) of the hole transport compound, N,N′-diphenyl-N,N′-bis(3-methyl-pheny)-(1,1′-biphenyl)-4,4′-diamine. In a four ounce brown bottle, 10 grams of MAKROLON® 5705 (available from Bayer Chemicals) was dissolved in 113 grams of methylene chloride. After the polymer was completely dissolved, 10 grams of N,N′-diphenyl-N,N′-bis(3-methylphenyl)-1,1′-biphenyl-4,4′-diamine was added to the solution. The mixture was shaken overnight to assure a complete solution. The solution was applied onto the photogenerator layer using a 4.5 mil Bird bar to form a coating. The coated device was then heated in a forced air oven at 120° C. for 1 minute to form a charge transport layer having a dry thickness of 29 micrometers.

### EXAMPLES 8-12

For Examples 8-12, photoreceptors were prepared as in Example 7 except they contained no adhesive layer and had varying amounts of ARDEL® D-100 polyarylate adhesive in the photogenerator layer (based on the overall solids of the photogenerator layer). Example 8 had 0% ARDEL® D-100 added to the photogenerator layer; Example 9 had 4% ARDEL® D-100; Example 10 had 6% ARDEL® D-100; Example 11 had 8% ARDEL® D-100; and Example 12 had 10% ARDEL® D-100.

### EXAMPLE 13

Testing of Peel Strength Adhesion. The photoreceptors of Examples 1 through 12 were evaluated for adhesive properties using a 180° (reverse) peel test.

The 180° peel strength was determined by cutting a minimum of five 0.5 inch×6 inches imaging member samples from each of Examples 1 through 12. For each sample, the charge transport layer was partially stripped from the test imaging member sample with the aid of a razor blade and then hand peeled to about 3.5 inches from one end to expose part of the underlying charge generating layer. The test imaging member sample was secured with its charge transport layer surface toward a 1 inch×6 inches×0.5 inch aluminum backing plate with the aid of two sided adhesive tape (1.3 cm (½ inch) width Scotch Magic Tape #810, available from 3M Company). In this condition, the anti-curl layer/substrate of the stripped segment of the test sample was easily peeled away 180° from the sample to cause the lower layer to separate from the charge generating layer.

The end of the resulting assembly opposite to the end from which the charge transport layer was inserted into the upper jaw of an Instron Tensile Tester. The free end of the partially peeled anti-curl/substrate strip was inserted into the lower jaw of the Instron Tensile Tester. The jaws were then activated at a 1 inch/min crosshead speed, a 2 inch chart speed, and a load range of 200 grams to 180° peel the sample at least 2 inches. The load monitored with a chart recorder was calculated to give the peel strength by dividing the average load required for stripping the anti-curl layer with the substrate by the width of the test sample. The results are set forth below in Table 1.

### EXAMPLE 14

Testing of Photoreceptor Sheets for Surface Potential After Exposure. The flexible photoreceptor sheets prepared as described in Examples 1 through 12 were tested for their xerographic sensitivity and cyclic stability in a scanner. In the scanner, each photoreceptor sheet to be evaluated was mounted on a cylindrical aluminum drum substrate, which was rotated on a shaft. The devices were charged by a corotron mounted along the periphery of the drum. The surface potential was measured as a function of time by capacitively coupled voltage probes placed at different locations around the shaft. The probes were calibrated by applying known potentials to the drum substrate. Each photoreceptor sheet on the drum was exposed to a light source located at a position near the drum downstream from the corotron. As the drum was rotated, the initial (pre-exposure) charging potential was measure by voltage probe 1. Further rotation lead to an exposure station, where the photoreceptor device was exposed to monochromatic radiation of a known intensity. The devices were erased by a light source located at a position upstream of charging.

The measurements illustrated in Table 1 below include the charging of each photoreceptor device in a constant current or voltage mode. The devices were charged to a negative polarity corona and the initial charging potential was measured by probe 1. The surface potential after exposure to monochromatic light at 6.0 ergs/cm² was measured by a second voltage probe. The devices were finally exposed to an erase lamp of 300 ergs/cm² and a third voltage probe measured any residual potential. Dark decay was determined as the difference between the initial charging potential and the charge potential after 0.66 seconds without exposure to monochromatic radiation.

The results of the peel strength adhesion test of Example 13 and the electrical measurements obtained in Example 14 are summarized below in Table 1.

TABLE 1

| | Peel | Vₑₓₚₒₛₑ 6.0 | | |
|---|---|---|---|---|
| | Strength, | ergs/cm² at | Dark Decay, | Vₑᵣₐₛₑ at |
| Example | gf/cm | 0 Cycles Volts | Volts | 0 Cycles Volts |
| 1 | Did not Peel | 102 | 64 | 34 |
| 2 | 19.8 | 103 | 63 | 34 |
| 3 | Did not Peel | 90 | 62 | 33 |
| 4 | Did not Peel | 91 | 50 | 33 |
| 5 | Did not Peel | 87 | 53 | 33 |
| 6 | Did not Peel | 94 | 48 | 33 |
| 7 | Did not Peel | 76 | 122 | 30 |
| 8 | 5.43 | 70 | 104 | 28 |
| 9 | 5.31 | 79 | 91 | 31 |
| 10 | 5.30 | 77 | 97 | 31 |
| 11 | 8.10 | 67 | 119 | 29 |
| 12 | Did not Peel | 72 | 107 | 30 |

As set forth in Table 1, compared with a photoreceptor device having a separate interfacial adhesive layer, equivalent peel strength was achieved with devices having no interfacial adhesive layer but having a photogenerator layer (CGL) doped with a polyarylate polymer, such as ARDEL® D-100. In the case of the BZP device with no interfacial layer, 4% or more of ARDEL® D-100 adhesive doped in CGL was sufficient to result in a no peel outcome, the same as the control device with a separate adhesive layer. For the HOGaPc device with no interfacial layer, 10% ARDEL® D-100 adhesive was necessary to obtain the same no peel result as that of the control device containing a separate interfacial adhesive layer. The above results indicate strong adhesion for devices having adhesive doped BZP and HOGaPc CGL layers, without the need for a separate adhesive layer.

The results in Table 1 also demonstrate that the electrical properties for photoreceptors having a photogenerator layer doped with 4-10% of a polyarylate adhesive were not significantly impacted in key xerographic characteristics such as V-background, dark decay and Vₑᵣₐₛₑ (the residual voltage on the photoreceptor).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A photoreceptor comprising a photogenerator layer comprising a mixture of a resin, a photogenerating component, and an adhesive component.

2. The photoreceptor of claim 1, wherein the resin is selected from the group consisting of polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof.

3. The photoreceptor of claim 1, wherein the resin is selected from the group consisting of poly(ethylene terephthalate), poly(tetramethylene hexamethylene diurethane), poly(styrene-co-maleic anhydride), polybutadiene-graft-poly(methyl acrylate-co-acrylontrile), poly(1,4-cyclohexane sulfone), poly(phenylene oxide), poly(phenylene sulfone), poly(phenylene oxide-co-phenylene sulfone), poly(ethylene-co-acrylic acid), poly(dimethylsiloxane), poly(ethyl acrylate), poly(hexamethylene adipamide), poly(pyromellitimide), poly(vinyl amine), poly(2,6-dimethyl-1,4-phenylene oxide), poly(hydroxyethers), poly([(o-cresyl glycidyl ether)-co-formaldehyde], poly(4-tert-butylphenol-co-formaldehyde), poly(4,4′-isopropylidene diphenyl carbonate), poly(4,4′-diphenyl-1,1′-cyclohexane carbonate), poly(4,4′-sulfonyl diphenyl carbonate), poly(4,4′-ethylidene diphenyl carbonate), poly(4,4′-methylidene diphenyl carbonate), poly(4,4′-(1,3-phenylenediisopropylidene)diphenyl carbonate), poly(4,4′-(1,4-phenylenediisopropylidene)diphenyl carbonate), poly(4,4′-hexafluoroisppropylidene diphenyl carbonate, and combinations thereof.

4. The photoreceptor of claim 1, wherein the photogenerating component is selected from the group consisting of metal phthalocyanines, metal free phthalocyanines, alkylhydroxyl gallium phthalocyanines, hydroxygallium phthalocyanines, and perylenes.

5. The photoreceptor of claim 1, wherein the photogenerating component is selected from the group consisting of bis(benzimidazo)perylene, titanyl phthalocyanines, vanadyl phthalocyanines, selenium, selenium alloys, and trigonal selenium.

6. The photoreceptor of claim 1, wherein the adhesive component is selected from the group consisting of polyarylates, polyurethanes, and mixtures of at least one of these adhesives with a carbazole polymer.

7. The photoreceptor of claim 1, wherein the resin comprises a polycarbonate, the photogenerating component is selected from the group consisting of hydroxygallium phthalocyanines and bis(benzimidazo)perylenes, and the adhesive component comprises a polyarylate.

8. The photoreceptor of claim 1, wherein the photogenerating component is present in the photogenerator layer in an amount of from about 5 weight percent to about 80 weight percent.

9. The photoreceptor of claim 1, wherein the photogenerating component is present in the photogenerator layer in an amount of from about 25 weight percent to about 60 weight percent.

10. The photoreceptor of claim 1, wherein the adhesive component is present in the photogenerator layer in an amount of from about 1 weight percent to about 20 weight percent.

11. The photoreceptor of claim 1, wherein the adhesive component is present in the photogenerator layer in an amount of from about 3 weight percent to about 12 weight percent.

12. The photoreceptor of claim 1, further comprising a charge transport layer.

13. The photoreceptor of claim 12, wherein the charge transport layer comprises hole transport molecules of an aryl amine.

14. The photoreceptor of claim 12, wherein the thickness of the photogenerator layer is from about 0.05 microns to about 10 microns and the thickness of the charge transport layer is from about 2 micrometers to about 50 micrometers.

15. A photoreceptor comprising a charge transport layer and a photogenerator layer comprising a resin, about 5 weight percent to about 80 weight percent of a photogenerating component selected from the group consisting of metal phthalocyanines, metal free phthalocyanines, alkylhydroxyl gallium phthalocyanines, hydroxygallium phthalocyanines and perylenes, and about 1 weight percent to about 20 weight percent of an adhesive selected from the group consisting of polyarylates, polyurethanes, and mixtures of at least one of these adhesives with a carbazole polymer.

16. The photoreceptor of claim 15, wherein the resin is selected from the group consisting of polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof.

17. The photoreceptor of claim 15, wherein the resin is selected from the group consisting of poly(ethylene terephthalate), poly(tetramethylene hexamethylene diurethane), poly(styrene-co-maleic anhydride), polybutadiene-graft-poly(methyl acrylate-co-acrylontrile), poly(1,4-cyclohexane sulfone), poly(phenylene oxide), poly(phenylene sulfone), poly(phenylene oxide-co-phenylene sulfone), poly(ethylene-co-acrylic acid), poly(dimethylsiloxane), poly(ethyl acrylate), poly(hexamethylene adipamide), poly(pyromellitimide), poly(vinyl amine), poly(2,6-dimethyl-1,4-phenylene oxide), poly(hydroxyethers), poly([(o-cresyl glycidyl ether)-co-formaldehyde], poly(4-tert-butylphenol-co-formaldehyde), poly(4,4′-isopropylidene diphenyl carbonate), poly(4,4′-diphenyl-1,1′-cyclohexane carbonate), poly(4,4′-sulfonyl diphenyl carbonate), poly(4,4′-ethylidene diphenyl carbonate), poly(4,4′-methylidene diphenyl carbonate), poly(4,4′-(1,3-phenylenediisopropylidene)diphenyl carbonate), poly(4,4′-(1,4-phenylenediisopropylidene)diphenyl carbonate), poly(4,4′-hexafluoroisppropylidene diphenyl carbonate, and combinations thereof.

18. The photoreceptor of claim 15, wherein the photogenerating component is present in the photogenerator layer in an amount of from about 25 weight percent to about 60 weight percent and the adhesive is present in the photogenerator layer in an amount of from about 3 weight percent to about 12 weight percent.

19. The photoreceptor of claim 15, wherein the resin comprises a polycarbonate, the photogenerating component is selected from the group consisting of hydroxygallium phthalocyanines and bis(benzimidazo)perylenes, and the adhesive component comprises a polyarylate.

20. The photoreceptor of claim 15, wherein the charge transport layer comprises hole transport molecules.

21. The photoreceptor of claim 15, wherein the thickness of the photogenerator layer is from about 0.05 microns to about 10 microns and the thickness of the charge transport layer is from about 2 micrometers to about 50 micrometers.

22. A composition comprising a resin, a photogenerating component, and an adhesive component.

23. The composition of claim 22 wherein the photogenerating component comprises about 5 weight percent to about 80 weight percent of the composition, the adhesive component comprises about 1 weight percent to about 20 weight percent of the composition, and the resin comprises about 20 weight percent to about 95 weight percent of the composition, wherein the total of said components is equal to about 100 percent.

24. The composition of claim 22 wherein the resin comprises a polycarbonate, the photogenerating component is selected from the group consisting of hydroxygallium phthalocyanines and bis(benzimidazo)perylenes, and the adhesive component comprises a polyarylate prepared from bisphenol-A and a mixture of 50 mol percent each of terephthalic and isophthalic acid chlorides.

25. The composition of claim 22 wherein the photogenerating component comprises about 25 weight percent to about 60 weight percent of the composition, the adhesive component comprises about 3 weight percent to about 12 weight percent of the composition, and the resin comprises about 40 weight percent to about 75 weight percent of the composition, wherein the total of said components is equal to about 100 percent.
